(19) United States
(12) Patent Application Publication
(10) Pub. No.: US 2008/0128258 A1
(43) Pub. Date: Jun. 5, 2008

(54) Pressure Sensitive Switching Element and Seat Sensor

(75) Inventor: Thomas Wittkowski, Hermeskeil (DE)

Correspondence Address: CANTOR COLBURN, LLP, 20 Church Street, 22nd Floor, Hartford, CT, 06103, US

(73) Assignee: IEE INTERNATIONAL ELECTRONICS & ENGINEERING S.A., Echternach (LU)

(21) Appl. No.: 11/814,783

(22) PCT Filed: Jan. 10, 2006
(86) PCT No.: PCT/EP06/50124

§ 371 Date: Sep. 19, 2007

(30) Foreign Application Priority Data
Jan. 26, 2005 (LU) 91 130

(51) Int. Cl. H01H 35/00

(52) U.S. Cl. 200/85 A

(57) ABSTRACT

A foil-type switching element comprises a first elastic carrier foil (A) having a first thickness (a) and a second elastic carrier foil (C) having a second thickness (c), which are arranged at a certain distance (b) from each other by means of a spacer (B). The switching element is configured such that a maximum deflection of at least one of said first or second carrier foils is equal to or greater than ⅘ of said distance (b) between said first and second carrier foils and/or a maximum deflection of at least one of said first or second carrier foil is equal to or greater than ⅘ of said thickness of said carrier foil.

### INTRODUCTION

The present invention generally relates to a foil-type switching element comprising a first carrier foil and a second carrier foil arranged at a certain distance from each other by means of a spacer. The spacer comprises at least one recess, which defines an active area of the switching element. At least two electrodes are arranged in the active area of the switching element between said first and second carrier foils in such a way that, in response to a pressure acting on the active area of the switching element, the first and second carrier foils are pressed together against the reaction force of the elastic carrier foils and an electrical contact is established between the at least two electrodes.

Several embodiments of such foil-type switching elements are well known in the art. Some of these switching elements are configured as simple switches comprising e.g. a first electrode arranged on the first carrier foil and a second electrode arranged on the second carrier foil in a facing relationship with the first planar electrode. The electrodes may be of a planar configuration covering essentially the entire surface of the respective carrier foil inside of the active area.

Other switching elements known in the art are configured as pressure transducers having an electrical resistance, which varies with the amount of pressure applied. In a first embodiment of such pressure transducers, a first electrode is arranged on the first carrier foil and a second electrode is arranged on the second carrier foil in facing relationship with the first electrode. At least one of the electrodes is covered by a layer of pressure sensitive material, e.g. a semi-conducting material, such that when the first and second carrier foils are pressed together in response of a force acting on the switching element, an electrical contact is established between the first and second electrode via the layer of pressure sensitive material. The pressure sensors of this type are frequently called to operate in a so called “through mode”.

In an alternative embodiment of the pressure transducers, a first and a second electrode are arranged in spaced relationship on one of the first and second carrier foils while the other carrier foil is covered with a layer of pressure sensitive material. The layer of pressure sensitive material is arranged in facing relationship to the first and second electrode such that, when said first and second carrier foils are pressed together in response to a force acting on the active area of the switching element, the layer of pressure sensitive material shunts the first and second electrode. These sensors are called to operate in the so-called “shunt mode”.

The above-described switching elements can be manufactured cost-effectively and have proven to be extremely robust and reliable in practice.

The electrical response of such a pressure sensors depends on the type of the electrodes, the presence of a possible layer of pressure sensitive material, the design of the electrodes and their arrangement within the active area of the switching element and finally on the physical contact, which is established between the electrodes in response to a force acting on the active area. The physical contact between the electrodes is determined by the mechanical response of the switching element in case of a force acting on the active area. This mechanical response depends on the elastic properties of the carrier foils, the lateral dimension of the active area and the distance between the two opposed carrier foils.

For a given size and configuration of the switching element, the mechanical response of both types of pressure sensors can be adapted by adjusting the mechanical properties of the carrier foils. The carrier foil of inexpensive foil-type switching elements usually consists of a plastic sheet material such as PET or PEN, which if necessary has undergone a surface treatment in order to enhance the adhesion on the printed electrodes. However the elastic properties of these materials do not always correspond to the requirements with respect to the mechanical response of the switching element. For instance, the graph of the modulus of elasticity versus temperature of PET or PEN shows a significant step at respective threshold temperatures, which confers a non-optimum behaviour to the switching element.

Another material, which is used for the carrier foils, is polyimide PI. The modulus of elasticity of PI shows only little variations over a wide temperature range e.g. from −50° C. to +200° C. This mechanical property of PI is well suited for the pressure sensor applications, however PI is very expensive compared to PET of PEN.

Thus there is a need for pressure sensors with enhanced carrier foils. In order to provide a solution to this problem, document WO-A-2004/053908 discloses a foil-type switching element wherein at least one carrier foil comprises a multi-layered configuration with at least two layers of different materials. By the use of appropriate materials and by suitably dimensioning the thickness of the different layers, the mechanical properties of these multi-layered carrier foils may be precisely tuned to the specific requirements of a wide range of applications. However, due to severe production tolerances, these multi-layered carrier foils are difficult to produce and accordingly rather high cost.

The present invention further relates sensor mats comprising a plurality of such foil-type switching elements. Such sensor mats are e.g. used for passenger presence detection, child seat detection, and/or occupant classification sensors in automotive vehicle seats. The information provided by such sensing mats or seat sensors during operation is used to improve the driver or passenger safety either by warning signals, by inflating or not inflating an airbag, or to ascertain the speed of airbag deployment.

The seat sensors may be used in combination with other sensors such as seat belt reminders or optical or infrared systems that measure the position of a person on the seat. Applications related to the operation of the airbag system are critical for the occupant safety and thus require the highest automotive standards of performance and reliability. On the other hand side the seat-integrated sensor mat must allow optimal air ventilation and it must be thin and flexible so that its presence in the vehicle seat does not negatively affect the seat comfort.

### OBJECT OF THE INVENTION

The object of the present invention is to provide am improved foil-type switching element.

### GENERAL DESCRIPTION OF THE INVENTION

In order to achieve this object, the present invention proposes a foil-type switching element comprising a first elastic carrier foil having a first thickness and a second elastic carrier foil having a second thickness, which are arranged at a certain distance from each other by means of a spacer. The spacer comprises at least one recess defining an active area of the switching element. At least two electrodes are arranged in the active area of the switching element between said first and second carrier foils in such a way that, in response to a pressure acting on the active area of the switching element, the first and second carrier foils are pressed together against the reaction force of the elastic carrier foils and an electrical contact is established between the at least two electrodes. According of the invention the switching element is configured such that a maximum deflection of at least one of said first or second carrier foils is equal to or greater than ⅘ of said distance between said first and second carrier foils and/or a maximum deflection of at least one of said first or second carrier foil is equal to or greater than ⅘ of said thickness of said carrier foil.

In a preferred embodiment of the invention, the foil-type switching element comprises at least one layer of pressure sensitive material, which is arranged such that said electrical contact between said electrodes is established via said pressure sensitive material.

Further to the single switching element, the present invention also proposes a seat sensor comprising a plurality of foil-type switching sensors as described above.

It will be noted, that the switching element according to the present invention is preferably configured as a pressure sensor or pressure transducer having an electrical resistance, which varies with the amount of pressure applied. In such an embodiment, the switching element comprises a layer of pressure sensitive material, which is arranged together with the electrodes in the active area of the switching element between said first and second carrier foils in such a way that, in response to a pressure acting on the active area of the switching element, the first and second carrier foils are pressed together against the reaction force of the elastic carrier foils and an electrical contact is established between the at least two electrodes via said layer of pressure sensitive material.

The proposed invention combines passenger comfort with highest sensor performance and reliability by using preferably at least two different types of commodity polymer films of complementary properties. The working principle and design of the switching elements and specifically their active areas as well as of the complete mat is specifically adapted for the employment of these polymer films.

Sensor mats for passenger presence detection, child seat detection or occupant classification in vehicle seats usually consist of an array of individual switching elements, each switching element having an active area. The mat if formed of three laminated polymer sheets, the inner one of which acts as the spacer. The typical thickness of a sensor mat is below 0.5 millimeters, so that the occupant cannot feel the sensor mat when it is arranged under the cushion in the passenger seat. An individual switching element consists of two elastic membranes separated by the spacer, which comprises a cut-out in the region of the active area of the switching element. A ventilation system assures that the hydrostatic pressure in the cell is the same as outside of the cell.

If a compressive pressure is applied at the active area of a switching element, the two carrier foils or membranes are deformed elastically towards each other until they touch each other above a certain pressure. If the switching element comprises at least one layer of pressure sensitive material, which is arranged such that contact between the electrodes is established via the pressure sensitive material, the electrical resistance between the electrodes is a function of the applied pressure. The resistance of each individual switching element provides accordingly a indication on the pressure acting on its active area.

During operation, a control unit records the resistance values of the different switching elements and an associated electronic logic is able to decide if a passenger sits on the seat, if a child seat is present or to classify occupant's attributes such as size and weight. The resistance—pressure curve of each cell must be highly reproducible for various climatic conditions over the sensor lifetime. The full digitized resistance—pressure curve is interpreted by the electronics over a typical pressure range from 10 to 500 millibars thus exceeding the functioning of a simple membrane switch by far.

In all state of the art seat sensor applications the maximum deflection of a membrane is equal to or smaller than ¾ of its thickness and it is equal to or smaller than ¾ of the membrane spacing. For example in a typical sensor with PI carrier foil, the thickness of the PI Membrane is typically about 125 μm, the spacer thickness is about 90 μm, and the deformability of the PI membrane is about 70 μm.

The state of the art technique to produce occupant classification sensors uses high performance polymer films consisting of polyimide (PI) or polyetherimide (PEI). At least one membrane is made of PI or PEI. This results in disproportionately high material costs in sensor production. The reason for using these materials is their excellent elastic behavior—their elastic modulus is approx. 3 Gigapascal at room temperature—which is characterized by a smooth linear decrease of the elastic modulus with increasing temperature in the temperature interval between −40° C. and 120° C. These materials further do not exhibit a glass transition in the temperature range up to 200° C. so that the unwanted creep of a membrane during long-term operation at elevated temperatures is completely avoided. The aging of these materials is small thus warranting unaltered mechanical properties over time under a variety of climatic conditions. The high softening temperature of more than 200° C. allows for a relatively high temperature in the sensor production process, especially in the ink curing processes.

The present invention proposes to replace high performance high cost films by lower priced commodity film materials without reducing the functionality and reliability of the sensor. This was made possible by a new design of the active cells as well as of the sensor mat.

The invention combines film materials with complementary properties under the exclusive employment of commodity polymer films. Consequently at least two different types of polymer films are preferably used. One film type, named type I hereafter, possesses high mechanical robustness, high E-modulus, and high chemical resistance. Deficiencies of the type I film are a low glass transition temperature thus not avoiding creep and a strong non-linear dependence of the elastic modulus from the temperature. The other film material, named type II hereafter, is complementary to type I in a sense that it possesses a linear relation between the E-modulus and the temperature between −40° C. and 120° C., and that its glass transition temperature is higher than 150° C. The type II material, however, exhibits a low E-modulus of approximately 2 Gigapascal, a low mechanical robustness as well as a low chemical resistance. A typical material of type I would be polyethylenetherephtalate (PET), and of type II polycarbonate (PC).

The sensor is formed by three flexible polymer films, two membranes and a spacer film between the membranes. The films may consist of the same or of different film materials or thicknesses. The total thickness of the active cell, or of the sensor mat, respectively, is equal to or smaller than 0.6 millimeters. The pressure working range is between 10 and 500 mbars and the minimum pressure at which the two membranes are touching is between 10 and 100 mbars.

A sensor built up of films of type I and II exhibits a comparable performance as if it is built up with a PI or PEI membrane but only if the cell design is adapted to a special working principle. This working principle states that the type I film takes over the majority of the mechanical robustness whereas the type II film takes over the majority of the elastic performance of the active cell. It follows that the film(s) of type II are thinner than the films of type I. Main reasons are the low mechanical robustness (of the folding endurance, e.g.) of film type II and the creep sensitivity of the type I film(s). The spacer may consist either of a film of type I or of another mechanically robust material.

The configuration of the cell should be such that such that a maximum deflection (normal to the foil plane, in the center of the sensor cell) of the membrane of type II is equal to or greater than ⅘ of said distance between the membranes (this distance corresponds substantially to a thickness of the spacer) and/or a maximum deflection of the membrane of type II is equal to or greater than ⅘ of said thickness of this membrane.

### DETAILED DESCRIPTION WITH RESPECT TO THE FIGURES

The present invention will be more apparent from the following description of several not limiting embodiments with reference to the attached drawings, wherein

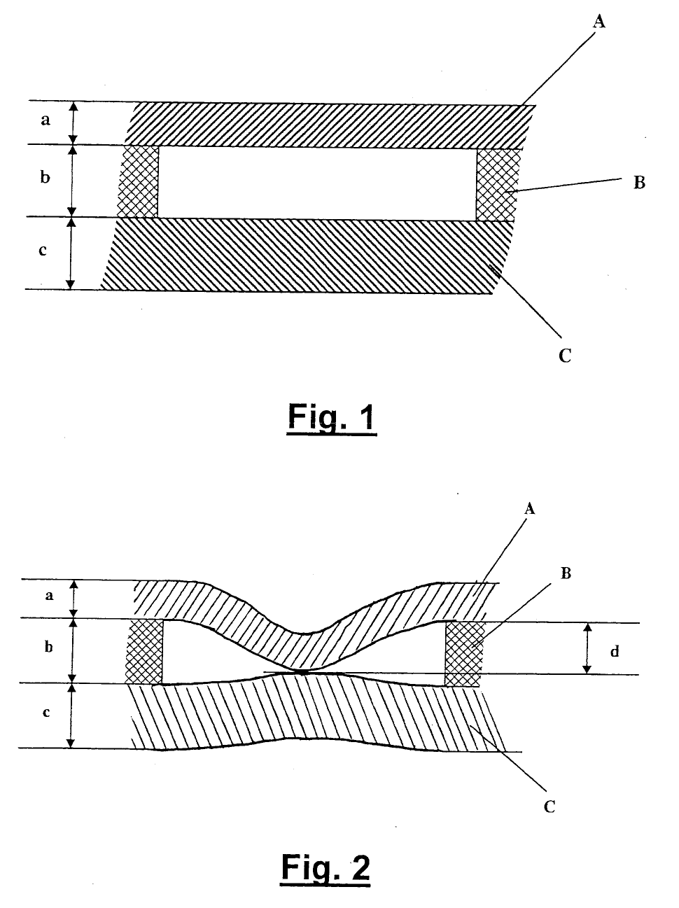

FIG. 1: shows a cross section of the membranes of a non-activated switching element;

FIG. 2: shows a cross section of the membranes of the switching element of FIG. 1, when a pressure force acts on the active area.

FIG. 1 shows a schematic cross-section of the active area region of a switching element without compressive pressure applied (not in scale). FIG. 2 shows a cross-section of the same cell with a compressive pressure applied that is high enough to deflect the membranes to their maximum amplitude (not in scale). The pressure may be unidirectional or uniaxial.

The switching element comprises a first membrane and a second membrane C, which are laminated together with a spacer membrane C. In FIGS. 1 and 2 ‘a’ denotes the thickness of membrane material ‘A’, ‘c’ labels the thickness of membrane material ‘C’, and ‘b’ labels the spacing between the membranes ‘A’ and ‘C’. The spacer material is denoted ‘B’. The maximum membrane deflection under a compressive pressure is labeled with ‘d’ in FIG. 2.

The skilled person will be aware, that a switching element further comprises at least two electrodes, which are arranged in the active area of the switching element between said first and second carrier foils in such a way that, in response to a pressure acting on the active area of the switching element, the first and second carrier foils are pressed together against the reaction force of the elastic carrier foils and an electrical contact is established between the at least two electrodes. These electrodes are however not shown in FIGS. 1 and 2.

There are two possible configurations that may overcome the material limitations in connection with the employment of commodity polymer films:
1) the switching element is symmetrical with respect to the mid plane of the spacer film. For these symmetrical switching elements the membrane thicknesses ‘a’ and ‘c’ are identical. Materials ‘A’ and ‘C’ denote the same film material of type II. The film ‘B’ is a film of type I.
2) the switching element is unsymmetrical with respect to the mid plane of the spacer film, i.e. the different membranes are made of different materials and/or have different dimensions, etc. In an unsymmetrical switching elements material ‘A’ is e.g. of type II and material ‘C’ is of type I. The spacer may be of the same material as membrane ‘C’ or it can consist of another film material of type I.

In both configurations both membranes are deflected under pressure. The membrane of type II, however, is deflected considerably more than the one of type I in the unsymmetrical case. Due to the working principle the shape of the deflected membranes as well as the local stresses and strains must be calculated by taking the in-plane strain of the membranes into account. The often-used bending theory for small deflections of thin plates applied to the present invention would not predict the cell operation properly. The construction details assure that any deflection of the membrane of type II takes place in the purely elastic regime.

The working principle which assures that films of types I and II perform complementary and which takes the boundary conditions—i.e. a sensor thickness below 0.6 millimeters, a measured pressure range from 10 to 500 millibars, and a minimum pressure at which the two membranes are touching between 10 and 100 millibars—into account, lead to the following construction rules:

a) the maximum deflection under pressure of at least one membrane, labeled with ‘d’ in FIG. 2, is equal or exceeds ⅘ of the spacing between the membranes, labeled with ‘b’., or

b) the maximum deflection under pressure of at least one membrane, labeled with ‘d’ in FIG. 2, is equal or exceeds ⅘ of the membrane thickness, labeled with ‘a’.

The invention employs low cost engineering commodity polymer films in high performance pressure sensing mats. This is realized by a combination of membrane and spacer materials and their respective thicknesses so that particular deficiencies in the mechanical properties of one material are compensated by the other material(s), which must have a superior performance with respect to that particular property. The cell is designed in a way that the involved materials behave complementary during operation thus ensuring the high performance of the active cell.

The mechanical robustness of the mat, which is arranged under the cushion of the occupant's seat, is provided by the film(s) of type I. In case of the unsymmetrical configuration the membrane of type II is on the top side of the mat and thus experiences less tensile stress than the bottom side membrane. In case of a symmetrical build up the spacer film of type I mainly contributes to the mat's robustness.

In order to make sure that the chemical aging of the film(s) of type II does not affect the sensor performance these films have to be protected. This is done either by 1.) a chemically inert coating on the film surface or 2.) by a protective wrapping. Such a wrapping is described in detail in patent WO 01/86676 A1. The wrapping is characterized by the following attributes. It protects the sensor mat against chemical aging. In particular it is impermeable to water. It assures that the hydrostatic atmosphere pressure inside and outside of the wrapping is the same. In the region of the active cells the wrapping is thin enough and loosely fixed so that it does not alter the elastic response of the active cells' membrane. Purely mechanical connections between groups of active cells consist only of the wrapping film thus simplifying a few production steps and leading to a lower mechanical stress in the sensor mat. The sensor mat and the wrapping are welded. The wrapping is used to support the fixation of the sensor mat in the seat.

1. Sensor mat for passenger presence detection, child seat detection and/or occupant classification comprising a plurality of foil-type switching elements configured as pressure sensors having an electrical resistance that varies with an amount of pressure applied,
wherein said foil-type switching elements respectively comprise
a first carrier foil having a first thickness and a second carrier foil having a second thickness, said first and second carrier foils being arranged at a certain distance from each other by means of a spacer, said spacer comprising at least one recess defining an active area of the switching element, and
at least two electrodes and at least one layer of pressure sensitive material arranged in the active area of the switching element between said first and second carrier foils in such a way that, in response to a pressure acting on the active area of the switching element, the first and second carrier foils are pressed together against the reaction force of the elastic carrier foils and an electrical contact is established between the at least two electrodes via said pressure sensitive material, characterized in that a maximum deflection of at least one of said first or second carrier foil is equal to or greater than ⅘ of said distance between said first and second carrier foils.

2. Sensor mat according to claim 1, wherein a maximum deflection of at least one of said first or second carrier foil is equal to or greater than ⅘ of said thickness of said carrier foil.

3. Sensor mat for passenger presence detection, child seat detection and/or occupant classification comprising a plurality of foil-type switching elements configured as pressure sensors having an electrical resistance that varies with an amount of pressure applied,
wherein said foil-type switching elements respectively comprise
a first carrier foil having a first thickness and a second carrier foil having a second thickness, said first and second carrier foils being arranged at a certain distance from each other by means of a spacer, said spacer comprising at least one recess defining an active area of the switching element, and
at least two electrodes and at least one layer of pressure sensitive material arranged in the active area of the switching element between said first and second carrier foils in such a way that, in response to a pressure acting on the active area of the switching element, the first and second carrier foils are pressed together against the reaction force of the elastic carrier foils and an electrical contact is established between the at least two electrodes via said pressure sensitive material, characterized in that a maximum deflection of at least one of said first or second carrier foil is equal to or greater than ⅘ of said thickness of said carrier foil.

4. Sensor mat according to claim 3, wherein a maximum deflection of at least one of said first or second carrier foil is equal to or greater than ⅘ of said distance between said first and second carrier foils.
